(19) United States
(12) Patent Application Publication
(10) Pub. No.: US 2007/0152646 A1
(43) Pub. Date: Jul. 5, 2007

(54) Circuit and method for providing programmed delays for power-up sequence using a single enable pin in a voltage regulator

(76) Inventor: Ajmal Godil, San Diego, CA (US)

Correspondence Address: DORSEY & WHITNEY LLP, 555 CALIFORNIA STREET, SUITE 1000, SUITE 1000, SAN FRANCISCO, CA, 94104, US

(21) Appl. No.: 11/323,631

(22) Filed: Dec. 29, 2005

(51) Int. Cl. G05F 1/00

(52) U.S. Cl. 323/282

(57) ABSTRACT

A circuit and methods for controlling the timing of regulated voltages supplied by a voltage regulator are provided. The circuit and method control the timing of the regulated voltages based on an enable voltage provided at an enable input of the voltage regulator. Different time delays may be provided, depending on the value of the enable voltage.

### FIELD OF THE INVENTION

The present invention relates generally to voltage regulators, and more particularly, to controlling the timing of voltages supplied by a voltage regulator.

### BACKGROUND INFORMATION

Voltage regulators are essential to the operation of most electronic devices. They convert a source voltage into a regulated DC voltage that is required to meet the devices' operating needs. An electronic device may need more than one voltage regulator, with each one providing a regulated DC voltage for a different component of the device. There are many types of voltage regulators available today, with switching voltage regulators being amongst the most popular.

It is often required to control the power-up and power-down timing of voltage regulators, especially when they are used in complex electronic devices, such as computers, portable communication devices, and integrated circuits (“ICs”), including microprocessors, application-specific integrated circuits (“ASICs”), and field-programmable gate arrays (“FPGAs”). These devices typically have multiple interconnected components, each with its own power needs. For example, many electronic devices supply power to different components in a predetermined time sequence when the electronic device is turned on. When initially powering-up the device, it is desirable to sequentially power up each component and wait until the power to one component stabilizes before supplying power to another component. Doing so may avoid latch-up and potentially damaging power spikes in the electronic devices.

Examples of prior-art circuits that control the power-up and power-down timing of voltage regulators include those disclosed in U.S. Pat. Nos. 4,151,425, 6,429,706, 6,462,438, and 6,691,239. These prior-art circuits, commonly referred to as “voltage sequencing circuits” as they sequence the timing of voltages supplied to loads, are typically external to voltage regulators and may require several resistors, capacitors, and other discrete components to control. Such circuits are complex and may require a significant amount of silicon die area to be implemented.

There is therefore a need to provide a simple circuit for controlling the timing of voltages supplied to loads with a voltage regulator.

### SUMMARY OF THE INVENTION

In view of the foregoing, the present invention provides a circuit for use with a voltage regulator, the voltage regulator including a first input adapted to receive a source voltage, a second input adapted to receive an enable voltage and an output for producing a regulated output voltage from the source voltage, the circuit comprising a reference input adapted to receive a reference voltage, a comparator coupled to the second input for generating an output based on a comparison of the enable voltage at the second input with the reference voltage at the reference input and a delay enable circuit coupled to the comparator for receiving the output from the comparator and delaying the regulated output voltage based on such output.

In one embodiment, the circuit may be used to provide a delay that is set by the combination of the enable voltage and the reference voltage, with the enable voltage provided by a voltage divider externally coupled to the second input. In another embodiment, the circuit may be used to provide a delay that is set by a capacitor externally coupled to the second input and charged by a current source internal to the voltage regulator.

### BRIEF DESCRIPTION OF THE DRAWINGS

The accompanying drawings, which are somewhat schematic in some instances and are incorporated in and form a part of this specification, illustrate several embodiments of the invention and, together with the description, serve to explain the principles of the invention.

FIG. 1 shows a schematic diagram of a voltage regulator in accordance with the present invention;

FIG. 2 shows a schematic diagram of an exemplary embodiment of a delay circuit for use with a voltage regulator in accordance with the present invention;

FIG. 3 shows a schematic diagram of three voltage regulators coupled to a single source voltage to generate three regulated output voltages at three given time delays in accordance with the exemplary embodiment of the delay circuit shown in FIG. 2;

FIG. 4 shows a schematic diagram of another exemplary embodiment of a delay circuit for use with a voltage regulator in accordance with the present invention;

FIG. 5 shows a schematic diagram of three voltage regulators coupled to a single source voltage to generate three regulated output voltages at three given time delays in accordance with the exemplary embodiment of the delay circuit shown in FIG. 4; and

FIG. 6 shows a timing diagram of the regulated output voltages generated by the circuits shown in FIGS. 3 and 5 in accordance with the present invention.

### DETAILED DESCRIPTION OF EMBODIMENTS OF THE INVENTION

Generally, in accordance with exemplary embodiments of the present invention, a circuit and a method are provided for controlling the timing of voltages supplied to loads with a voltage regulator. As stated herein, a voltage regulator generally refers to a circuit used to convert a source voltage into a regulated output voltage. The source voltage coupled to the voltage regulator may be a fluctuating voltage, e.g., such as that provided by a power supply connected to a wall socket, or at a given amplitude, e.g., 5 Volts. A linear voltage regulator, as used herein, generally refers to a voltage regulator designed with one or more transistors operating in their linear region. A switching voltage regulator, as used herein, generally refers to a voltage regulator designed with one or more switching elements and one or more energy storage and transfer elements between the source voltage and an output load.

In an exemplary embodiment of the present invention, a voltage regulator may have an enable input pin to receive an enable voltage for indicating whether to enable or disable the voltage regulator. In accordance with the present invention, the enable voltage can be used to generate time delays for delaying the regulated output voltage generated by the voltage regulator.

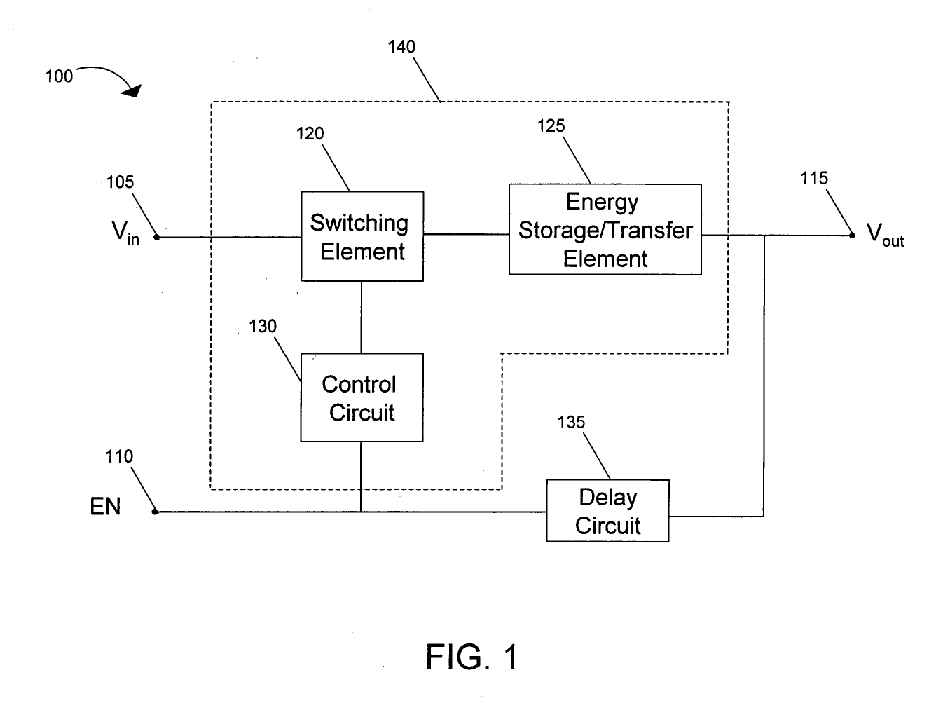

An exemplary schematic diagram of a voltage regulator in accordance with the present invention is provided in FIG. 1. Voltage regulator 100 is a switching voltage regulator and has a first input (input 105) for receiving source voltage Vᵢₙ and a second input (input 110) for receiving an enable voltage EN to generate regulated output voltage Vₒᵤₜ from source voltage Vᵢₙ at output 115. Switching voltage regulator 100 may be designed with switching element 120 coupled to input 105, an energy storage and transfer element 125 coupled between switching element 120 and output 115, and a control circuit 130 coupled between switching element 125 and input 110.

Switching element 120 may be of any suitable type, such as, for example, a metal-oxide semiconductor field-effect transistor (“MOSFET”), a field-effect transistor (“FET”), and a bipolar junction transistor (“BJT”), among others. Energy storage/transfer element 125 may include, for example, an inductor, a capacitor, and a transformer, or any combination thereof. Control circuit 130 may include circuitry to enable or disable the switching regulator based on the enable voltage EN at input 110 and circuitry to control the ON and OFF times of switching element 120. Such circuitry may include, for example, pulse width modulation (“PWM”), pulse frequency modulation (“PFM”) control circuitry, or linear control circuitry used with low dropout voltage regulators.

In accordance with the present invention, switching voltage regulator 100 also includes means for delaying the regulated output voltage based on the enable voltage. The means for delaying the regulated output voltage may include delay circuit 135 coupled between input 110 and output 115, which provides time delays for controlling the timing of regulated output voltage Vₒᵤₜ at output 115. In one exemplary embodiment, delay circuit 135 may generate up to four different time delays depending on four different ranges for the enable voltage EN applied to enable input 110. In another exemplary embodiment, delay circuit 135 may generate a time delay according to the time it takes to charge a capacitor coupled to enable input 110.

It is appreciated that switching element 120, energy storage and transfer element 125, and control circuit 130 may form voltage regulator 140 coupled to delay circuit 135. It is also appreciated that delay circuit 135 may be internal to a switching voltage regulator, such as shown internal to switching voltage regulator 100 or external to a switching voltage regulator, such as shown external to voltage regulator 140. Further, it is appreciated that delay circuit 135 may be used with other types of voltage regulators, including linear voltage regulators, without deviating from the principles and embodiments of the present invention.

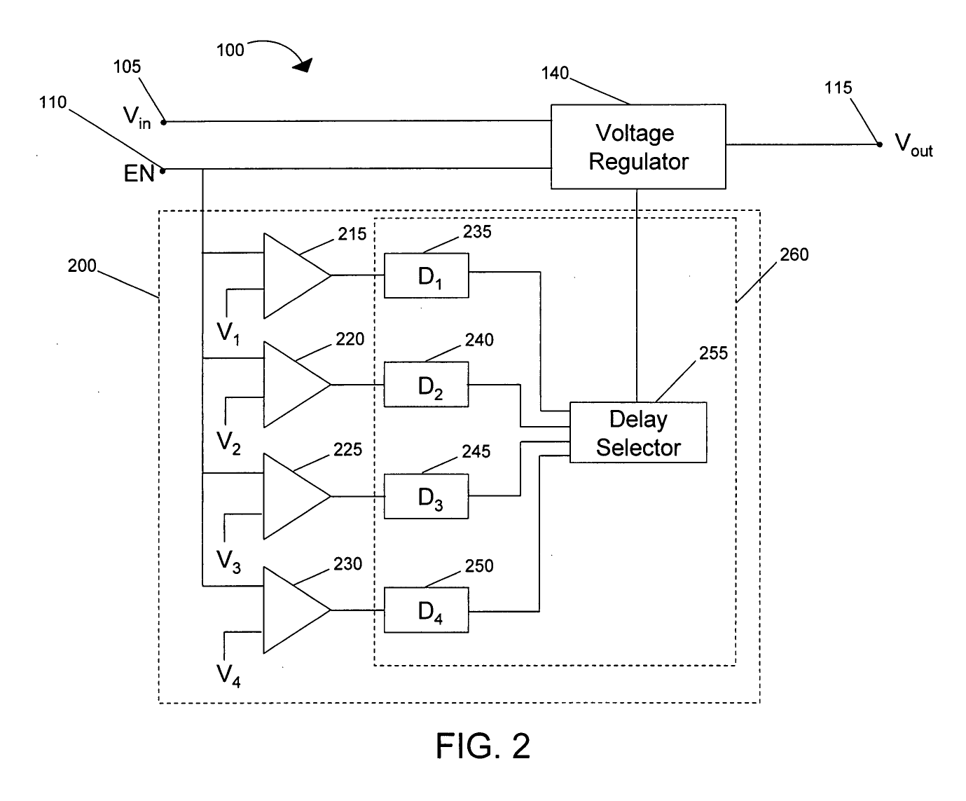

An exemplary schematic diagram of one embodiment of delay circuit 135 for use with a voltage regulator in accordance with the present invention is illustrated in FIG. 2. In this embodiment, delay circuit 200, for use with a voltage regulator such as voltage regulator 140, generates the time delays with a simple design involving comparators 215, 220, 225, and 230 adapted to receive reference voltages V₁-V₄, respectively, and coupled to input 110 to generate outputs based on comparisons of the enable voltage EN at input 110 and reference voltages V₁-V₄ and delay enable circuit 260, coupled to the outputs of comparators 215, 220, 225, and 230 for delaying the regulated output voltage Vₒᵤₜ based on such outputs.

Comparators 215, 220, 225, and 230 compare the enable voltage EN at input 110 with reference voltages V₁-V₄, respectively. Reference voltages V₁-V₄ have a range ranging from a minimum reference voltage and a maximum reference voltage. When the enable voltage EN falls between the minimum reference voltage and the maximum reference voltage at a given comparator, a time delay is generated by a delay element coupled to the comparator, such as delay element 235 coupled to the output of comparator 215, delay element 240 coupled to the output of comparator 220, delay element 245 coupled to the output of comparator 225, and delay element 250 coupled to the output of comparator 230.

For example, when the enable voltage EN is within the range of V₁, delay element 235 will generate a delay for delaying the regulated output voltage Vₒᵤₜ at output 115 by that delay. And when the enable voltage EN is within the range of V₂, delay element 240 will generate a delay for delaying the regulated output voltage Vₒᵤₜ at output 115 by that delay. Delay selector 255 may be used to select the time delay generated by a given delay element, i.e., delay elements 235, 240, 245, and 250, to apply to the regulated output voltage Vₒᵤₜ at output 115. Table 1 below shows exemplary values of enable voltage EN at input 110 and respective reference voltages V₁-V₄ to generate time delays D₁-D₄ that are applied to regulated output voltage Vₒᵤₜ at output 115.

TABLE 1
Exemplary voltages and time delays

| Enable Voltage | Reference | Time |
|---|---|---|
| (EN) | Voltage | Delay |
| 0.8 V +/− 0.2 Volts | V₁ | 5 ms |
| 1.2 V +/− 0.2 Volts | V₂ | 10 ms |
| 1.6 V +/− 0.2 Volts | V₃ | 15 ms |
| 2.0 V +/− 0.2 Volts | V₄ | 20 ms |

As seen in Table 1, the reference voltages V₁-V₄ have a range ranging from a minimum reference voltage and a maximum reference voltage. For example, when enable voltage EN at input 110 has a value, for example, within the range 0.8 Volts +/−0.2 Volts of reference voltage V₁, a time delay D₁ of 5 milliseconds is generated. That is, regulated output voltage Vₒᵤₜ at output 115 will be delayed by 5 milliseconds. As understood by one of ordinary skill in the art, enable voltage EN at input 110 and reference voltages V₁-V₄ may have different values than those shown in Table 1 to generate time delays D₁-D₄, which may also take on different values than those shown in Table 1. The values shown in Table 1 are shown for illustration purposes only, and other values may be used without deviating from the principles and embodiments of the present invention.

It is appreciated that voltage regulator 140 shown in FIG. 2 is merely exemplary and may be of any suitable type, including a switching or a linear voltage regulator. Voltage regulator 140 may comprise, for example, switching element 120, energy storage and transfer element 125, and control circuit 130. Further, it is appreciated that voltage regulator 140 may be designed with additional components not shown in FIGS. 1-2 without deviating from the principles and embodiments of the present invention. For example, voltage regulator 140 may have resistors, more than one switching element and energy storage/transfer elements, and other control circuitry. It is appreciated that voltage regulator 140 may be a buck, boost, buck-boost, flyback, push-pull, half-bridge, full-bridge switching voltage regulator, or any other suitable type of a switching or linear voltage regulator. It is also appreciated that delay circuit 200 may be external (as shown in FIG. 2) or internal to a voltage regulator without deviating from the principles and embodiments of the present invention.

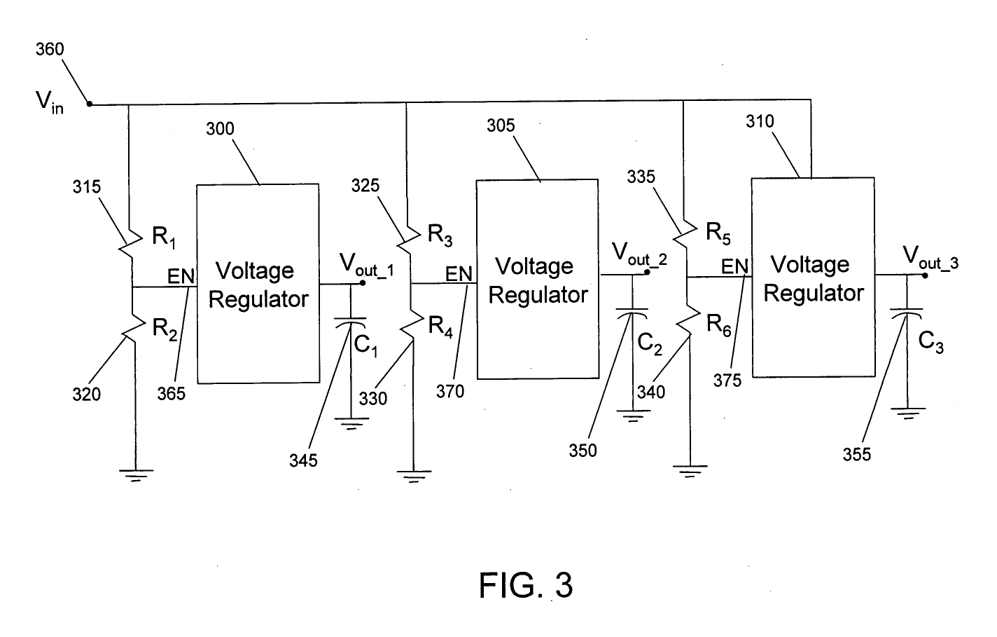

An exemplary schematic diagram of three voltage regulators coupled to a single source voltage to generate three regulated output voltages at three given time delays in accordance with the exemplary embodiment of delay circuit 200 shown in FIG. 2 is shown in FIG. 3. Voltage regulators 300, 305 and 310, each of which can be a linear voltage regulator or a switching voltage regulator substantially similar to switching voltage regulator 100 described above, are shown coupled to the same source voltage Vᵢₙ at input 360 to generate regulated output voltages Vₒᵤₜ_{_{—}}₁, Vₒᵤₜ_{_{—}}₂, and Vₒᵤₜ_{_{—}}₃, respectively. Regulated output voltages Vₒᵤₜ_{_{—}}₁, Vₒᵤₜ_{_{—}}₂, and Vₒᵤₜ_{_{—}}₃ may be provided, for example, to different components of an electronic device in a voltage sequencing application.

In accordance with the principles and embodiments of the present invention, voltage regulators 300, 305 and 310 generate regulated output voltages Vₒᵤₜ_{_{—}}₁, Vₒᵤₜ_{_{—}}₂, and Vₒᵤₜ_{_{—}}₃ at different times by providing different enable voltages EN at enable inputs 365, 360, and 375 to internal delay circuit 200, i.e., internal to each one of voltage regulators 300, 305, and 310 respectively. Different enable voltages EN are provided at enable inputs 365, 370, and 375 of voltage regulators 300, 305, and 310, respectively, from the same source voltage Vᵢₙ at input 360 by using voltage dividers.

For example, a voltage divider formed by resistors 315 and 320 is used to generate an enable voltage EN that, when input at voltage regulator 300 at input 365, is used by delay circuit 120 internal to voltage regulator 300 to delay the regulated output voltage Vₒᵤₜ_{_{—}}₁. Similarly, a voltage divider formed by resistors 325 and 330 is used to generate an enable voltage EN that, when input at voltage regulator 305 at input 370, is used by delay circuit 120 internal to voltage regulator 305 to delay regulated output voltage Vₒᵤₜ_{_{—}}₂. Further, a voltage divider formed by resistors 335 and 340 is used to generate an enable voltage EN that, when input at voltage regulator 310 at input 375, is used by delay circuit 120 internal to voltage regulator 310 to delay regulated output voltage Vₒᵤₜ_{_{—}}₃.

It is appreciated that resistor pairs 315 and 320, 325 and 330, and 335 and 340 may take on any value in accordance with delay specifications of voltage regulators 300, 305 and 310 for producing different time delays. For example, resistor pair 315 and 320 may take on a value within a range of a reference voltage V1 shown in Table 1 for generating regulated output voltage Vₒᵤₜ_{_{—}}₁ with a delay of 5 ms.

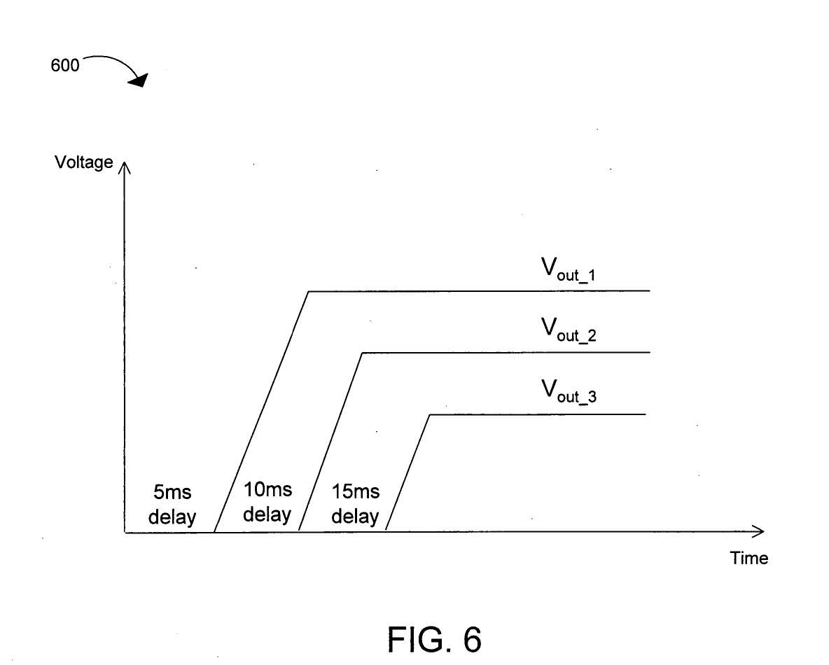

In accordance with the present invention, regulated output voltages Vₒᵤₜ_{_{—}}₁, Vₒᵤₜ_{_{—}}₂, and Vₒᵤₜ_{_{—}}₃ may be generated at any given time delay allowed by delay specifications provided with voltage regulators 300, 305, and 310. Such delay specifications may be, for example, those shown in Table 1. Delay specifications shown in Table 1 enables voltage regulators 300, 305 and 310 to offer up to four different time delays for generating regulated output voltages at different times. For example, regulated output voltages Vₒᵤₜ_{_{—}}₁, Vₒᵤₜ_{_{—}}₂, and Vₒᵤₜ_{_{—}}₃ may be generated at time delays of 5 ms, 10 ms, and 15 ms, respectively, as shown in exemplary timing diagram 600 shown in FIG. 6.

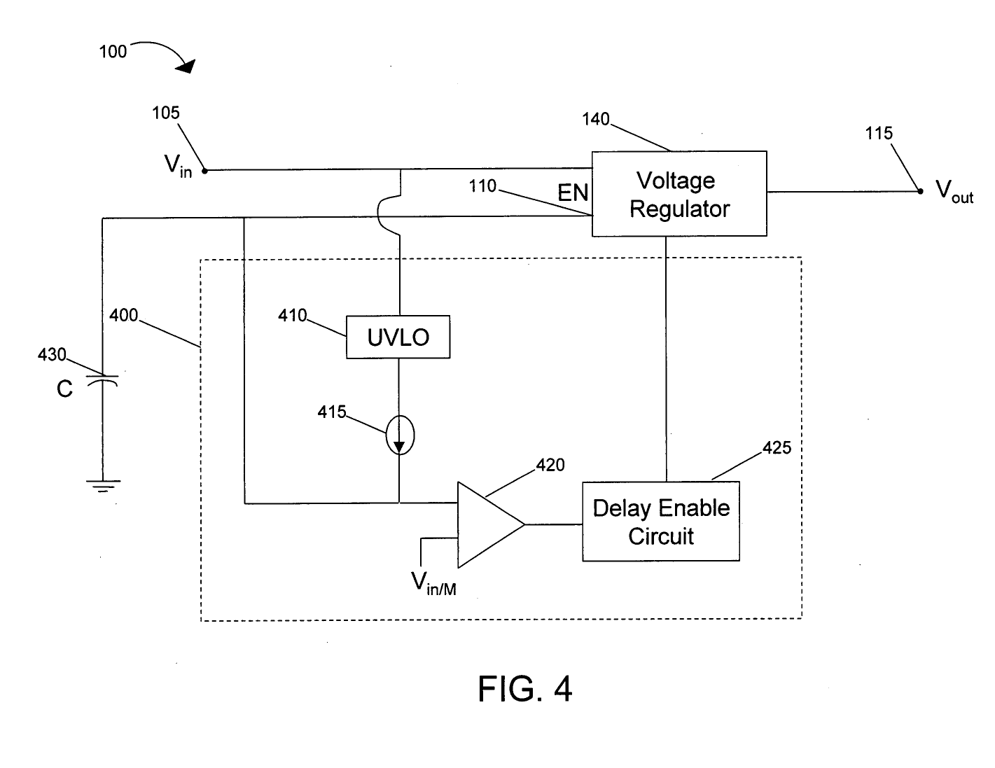

A schematic diagram of another embodiment of delay circuit 135 for use with a voltage regulator in accordance with the present invention is illustrated in FIG. 4. In this embodiment, delay circuit 400, for use with a voltage regulator such as voltage regulator 140, generates a time delay with a simple design involving current source 415 coupled to input 105, comparator 420 coupled to current source 415, and delay enable circuit 425 coupled between comparator 420 and output 115. External capacitor 430 is coupled to enable input 110. The time delay generated by delay circuit 400 corresponds to the time it takes to charge external capacitor 430 with current source 415.

Current source 415 becomes active and starts charging external capacitor 430 when source voltage Vᵢₙ crosses the programmable undervoltage lockout (“UVLO”) threshold specified for voltage regulator 140. UVLO circuit 410, coupled between input 105 and current source 415, is provided to compare the source voltage Vᵢₙ with the UVLO threshold, which may be, for example, on the order of 2.5-3.5 Volts.

Upon Vᵢₙ crossing the UVLO threshold, current source 415 starts charging capacitor 430 up to a reference voltage that is a fraction of Vᵢₙ, for example, Vᵢₙ/M, with M an integer, such as M=2, 3, 4, etc. Once capacitor 430 is charged up to reference voltage Vᵢₙ/M, comparator 420 activates delay enable circuit 425 to generate regulated output voltage 115 with a time delay corresponding to the time it takes to charge capacitor 430 to the reference voltage Vᵢₙ/M. In this embodiment, delay enable circuit 425 may be, for example, an enable or turn-on cell within switching voltage regulator 100.

For example, for Vᵢₙ=3.3 Volts and with capacitor 430 being a one microfarad capacitor, a current source of two microamperes may take approximately 412 milliseconds to charge up to a Vᵢₙ/4 reference voltage of 0.82 Volts before triggering delay enable circuit 425 to allow voltage regulator 400 to output regulated output voltage Vₒᵤₜ at output 115. By using a 0.1 microfarad capacitor, the time delay may be reduced to 41.2 mS.

It is appreciated that with this embodiment the time delay generated is set by external capacitor 430. Different time delays may be generated by choosing different values for external capacitor 430.

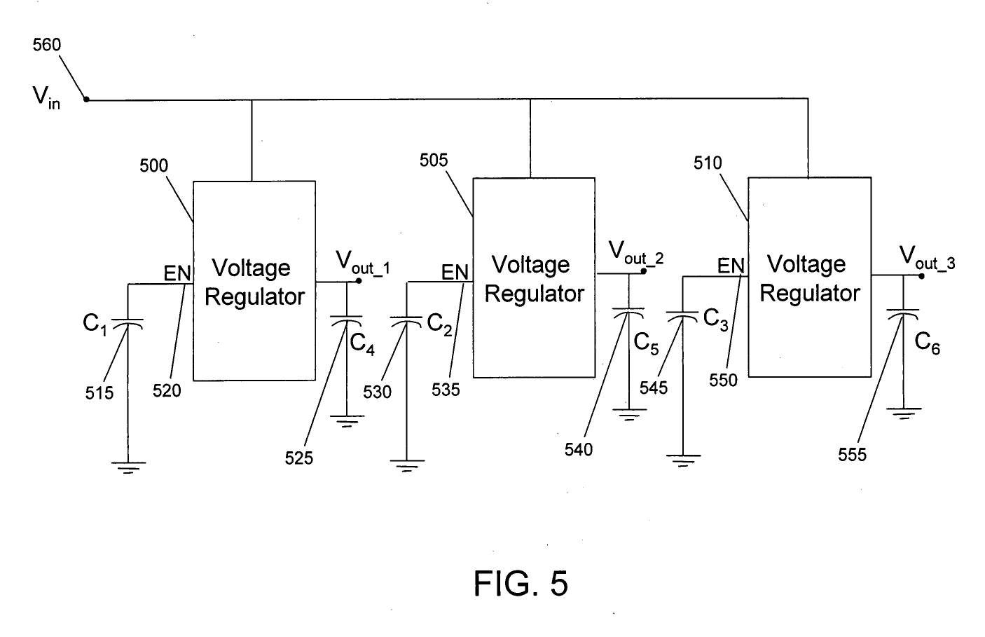

A schematic diagram of three voltage regulators coupled to a single source voltage to generate three regulated output voltages at three given time delays in accordance with the exemplary embodiment of delay circuit 135 shown in FIG. 4 is shown in FIG. 5. Voltage regulators 500, 505, and 510, each of which can be a linear voltage regulator or a switching voltage regulator substantially similar to switching voltage regulator 100 described above, are shown coupled to the same source voltage Vᵢₙ at input 560 to generate regulated output voltages Vₒᵤₜ_{_{—}}₁, Vₒᵤₜ_{_{—}}₂, and Vₒᵤₜ_{_{—3}}, respectively. Regulated output voltages Vₒᵤₜ_{_{—}}₁, Vₒᵤₜ_{_{—}}₂, and Vₒᵤₜ_{_{—}}₃ may be provided, for example, to different components of an electronic device in a voltage sequencing application.

In accordance with the principles and embodiments of the present invention, voltage regulators 500, 505, and 510 generate regulated output voltages Vₒᵤₜ_{_{—}}₁, Vₒᵤₜ_{_{—}}₂, and Vₒᵤₜ_{_{—}}₃ at different times by providing different enable voltages EN at enable inputs 520, 535, and 550, respectively. Different enable voltages EN are provided at enable inputs 520, 535, and 550 of voltage regulators 500, 505, and 510, respectively, from the same source voltage Vᵢₙ at input 560 by using different values of external capacitors 515, 530, and 545.

External capacitor 515, for example, is used to generate an enable voltage EN that, when input at voltage regulator 500 at input 520, generates a delay for delaying the regulated output voltage Vₒᵤₜ_{_{—}}₁. Similarly, external capacitor 530 is used to generate an enable voltage EN that, when input at voltage regulator 505 at input 535, generates a delay for delaying the regulated output voltage Vₒᵤₜ_{_{—}}₂. Further, external capacitor 545 is used to generate an enable voltage EN that, when input at voltage regulator 510 at input 550, generates a delay for delaying the regulated output voltage Vₒᵤₜ_{_{—}}₃.

It is appreciated that external capacitors 515, 530, and 545 may take on any value for producing different time delays. For example, regulated output voltages Vₒᵤₜ_{_{—}}₁, Vₒᵤₜ_{_{—}}₂, and Vₒᵤₜ_{_{—}}₃ may be generated at time delays of 5 ms, 10 ms, and 15 ms, respectively, as shown in exemplary timing diagram 600 shown in FIG. 6, corresponding to different values for external capacitors 515, 530, and 545.

Advantageously, a designer of an electronic device containing several components may, for example, use voltage regulators 500, 505 and 510 to provide different voltages at different times for each component at power-up. The designer may do so by choosing external capacitors that can be charged up to the fraction of the source voltage input at the comparator, such as Vᵢₙ/M input at comparator 420, by the current source internal to the voltage regulators, such as current source 415.

Another advantage is that delay circuit 135 (FIGS. 1, 2, and 4) may be internal or external to a voltage regulator, thereby enabling a designer of an electronic device to generate delayed regulated output voltages using very simple circuitry that occupies a small die area as compared to currently available voltage sequencing circuits.

The foregoing descriptions of specific embodiments and best mode of the present invention have been presented for purposes of illustration and description only. They are not intended to be exhaustive or to limit the invention to the precise forms disclosed. Specific features of the invention are shown in some drawings and not in others, for purposes of convenience only, and any feature may be combined with other features in accordance with the invention. Steps of the described processes may be reordered or combined, and other steps may be included. The embodiments were chosen and described in order to best explain the principles of the invention and its practical application, to thereby enable others skilled in the art to best utilize the invention and various embodiments with various modifications as are suited to the particular use contemplated. Further variations of the invention will be apparent to one skilled in the art in light of this disclosure and such variations are intended to fall within the scope of the appended claims and their equivalents.

What is claimed is:

1. A circuit for use with a first reference voltage and a voltage regulator having a first input for receiving a source voltage, a second input for receiving an enable voltage and an output for producing a regulated output voltage from the source voltage, the circuit comprising a first reference input adapted to receive the first reference voltage, a first comparator coupled to the second input for generating an output based on a comparison of the enable voltage at the second input with the first reference voltage at the first reference input and a delay enable circuit coupled to the first comparator for receiving the output from the first comparator and delaying the regulated output voltage based on such output.

2. The circuit of claim 1, wherein the voltage regulator comprises a linear voltage regulator.

3. The circuit of claim 1, wherein the voltage regulator comprises a switching voltage regulator.

4. The circuit of claim 1, wherein the first reference voltage comprises a first minimum reference voltage and a first maximum reference voltage.

5. The circuit of claim 4, wherein the output of the first comparator is a first voltage level when the enable voltage falls between the first minimum reference voltage and the first maximum reference voltage and a second voltage level when the enable voltage falls outside the first minimum reference voltage and the first maximum reference voltage.

6. The circuit of claim 1, wherein the delay enable circuit comprises a first delay element comprising an input coupled to the comparator and an output coupled to the voltage regulator, the output comprising a delayed version of the input when the output of the first comparator is the first voltage level.

7. The circuit of claim 6, further comprising a second reference input for receiving a second reference voltage, a second comparator coupled to the second input for comparing the enable voltage with the second reference voltage, a second delay element coupled to the second comparator for delaying the regulated output voltage based on the output of the second comparator and a delay selector coupled to the first delay element and the second delay element for selecting a delay to apply to the regulated output voltage, the delay selected from the first delay element or the second delay element based on the enable voltage.

8. The circuit of claim 1, wherein the first reference voltage comprises a fraction of the source voltage.

9. The circuit of claim 8, wherein the delay enable circuit comprises an enable cell for enabling the regulated output voltage after a time delay.

10. The circuit of claim 9, further comprising a current source coupled between the first input and the comparator.

11. The circuit of claim 10, further comprising a capacitor coupled to the current source and the comparator.

12. A method for delaying a regulated output voltage provided by a voltage regulator, the voltage regulator comprising a first input adapted to receive a source voltage, a second input adapted to receive an enable voltage and an output for generating a regulated output voltage from the source voltage, the method comprising delaying the regulated output voltage based on the enable voltage at the second input.

13. The method of claim 12, wherein delaying the regulated output voltage based on the enable voltage comprises delaying the regulated output voltage based on a comparison of the enable voltage and a reference voltage.

14. The method of claim 12, wherein the reference voltage comprises a minimum reference voltage and a maximum reference voltage.

15. The method of claim 14, further comprising generating a first voltage level when the enable voltage falls between the minimum reference voltage and the maximum reference voltage and a second voltage level when the enable voltage falls outside the minimum reference voltage and the maximum reference voltage.

16. The method of claim 15, wherein the regulated output voltage is delayed when the comparison step generates the first voltage level.

17. The method of claim 12, wherein the reference voltage comprises a fraction of the source voltage.

18. The method of claim 12, further comprising coupling a capacitor to the second input and charging the capacitor to generate the enable voltage.

19. The method of claim 18, further comprising charging the capacitor up to the reference voltage to generate a time delay.

20. A switching voltage regulator for use with a source voltage and an enable voltage, comprising a first input adapted to receive the source voltage, a second input adapted to receive the enable voltage, a switching element coupled to the first input, an energy storage element coupled to the switching element, a control circuit coupled to the second input and the switching element for controlling the powering up and powering down of the switching element, an output coupled to the switching element and a delay circuit coupled between the second input and the output for delaying the regulated output voltage at the output based on the enable voltage at the second input.

21. The switching voltage regulator of claim 20, wherein the switching element is selected from the group consisting of: a field-effect transistor; a metal-oxide semiconductor field-effect transistor; and a bipolar junction transistor.

22. The switching voltage regulator of claim 20, wherein the energy storage element is selected from the group consisting of: a capacitor; and an inductor.

23. The switching voltage regulator of claim 20, for use with a reference voltage, wherein the delay circuit includes a reference input adapted to receive the reference voltage, a comparator coupled to the second input and the reference input for generating an output based on a comparison of the enable voltage at the second input with the reference voltage at the reference input and a delay enable circuit coupled to the comparator for receiving the output from the comparator and delaying the regulated output voltage based on such output.

24. The switching voltage regulator of claim 23, wherein the reference voltage comprises a minimum reference voltage and a maximum reference voltage.

25. The switching voltage regulator of claim 24, wherein the output of the comparator is a first voltage level when the enable voltage falls between the minimum reference voltage and the maximum reference voltage and a second voltage level when the enable voltage falls outside the minimum reference voltage and the maximum reference voltage.

26. The switching voltage regulator of claim 25, wherein the regulated output voltage is delayed when the output of the comparator is the first voltage level.

27. A circuit for delaying a regulated output voltage provided by a voltage regulator for use with a source voltage and an enable voltage including a first input adapted to receive the source voltage, a second input adapted to receive the enable voltage and an output for producing a regulated output voltage from the source voltage, the circuit comprising means for delaying the regulated output voltage based on the enable voltage at the second input.

28. The circuit of claim 27, wherein the means for delaying the regulated output voltage comprise means for delaying the regulated output voltage based on a comparison of the enable voltage with a reference voltage.
